(19) United States
(12) Patent Application Publication
(10) Pub. No.: US 2017/0078389 A1
(43) Pub. Date: Mar. 16, 2017

(54) APPARATUS AND METHOD TO RECORD LOG INFORMATION AT HIGH-SPEED IN A BUFFER DIVIDED INTO RECENT AND OLD LOG AREAS

(71) Applicant: FUJITSU LIMITED, Kawasaki-shi (JP)

(72) Inventor: Kohta Nakashima, Kawasaki (JP)

(73) Assignee: FUJITSU LIMITED, Kawasaki-shi (JP)

(21) Appl. No.: 15/246,906

(22) Filed: Aug. 25, 2016

(30) Foreign Application Priority Data
Sep. 10, 2015 (JP) 2015-178665

(51) Int. Cl. H04L 29/08; H04L 12/861

(52) U.S. Cl. CPC H04L 67/1097; H04L 49/9005

(57) ABSTRACT

An apparatus includes a buffer-area whose size is limited. The buffer-area includes element areas each configured to store a single piece of log-information, and is divided into a first log-area that stores recent log-information and a second log-area that stores old log-information. When recording a new piece of log-information to the buffer-area, the apparatus determines whether the new piece of log-information is to be recorded in the first or second log-area. The apparatus writes the new piece of log-information to the first and second log-areas when the new piece of log-information is determined to be recorded in the first and second log-areas, respectively. When there are no element areas available for the new piece of log-information left in the first or second log-area, the apparatus changes allocation information configured to allocate each element area in the buffer-area to one of the first and second log-areas.

### CROSS-REFERENCE TO RELATED APPLICATION

This application is based upon and claims the benefit of priority of the prior Japanese Patent Application No. 2015-178665, filed on Sep. 10, 2015, the entire contents of which are incorporated herein by reference.

### FIELD

The embodiments discussed herein are related to apparatus and method to record log information at high-speed in a buffer divided into recent and old log areas.

### BACKGROUND

When log data are recorded in a buffer the size of which is limited, it is preferable that recent data are densely retained and old data are kept for a longest possible time even if only sparsely. FIG. 11 is a diagram illustrating such a recording method of log data. In a method illustrated in FIG. 11, at least m pieces of the most recent data are retained, and of the older data other than the m pieces of the most recent data, one piece of data for every p pieces of data are retained dating back to an oldest possible time.

FIG. 12 is a diagram illustrating an example of a record of log data. In FIG. 12, the size of a buffer is 20. Addresses A to T are assigned to element areas that are the storage locations of each data in the buffer. Data are stored in the buffer, such that the largest possible number of pieces of data are retained, the most recent 10 pieces of continuous data are retained, and data are retained as a long-term data over a longest possible time period by keeping one piece of data out of every five pieces of data.

As illustrated in FIG. 12, in the first round, the 0th to 19th sequence data are written to addresses A to T respectively in a sequential order. Then, in the second round, the 20th sequence data is written to address B so as to retain the 0th sequence data. Furthermore, the 21st to 23rd sequence data are respectively overwritten to addresses C to E. Next, the 24th sequence data is written to address G, not to address F that stores the 5th sequence data, such that one piece of data out of every five pieces of data is retained. Similarly, addresses K and P that respectively store the 10th and the 15th sequence data, are not overwritten with data, as the element areas to be skipped.

Then, in the third round, addresses A, B, F, H, K, N, P, and T that store the 0th, 20th, 5th, 25th, 10th, 30th, 15th, and 35th sequence data respectively are not overwritten with data, as the element areas to be skipped. Similarly, in the fourth round, addresses A, B, F, H, I, K, N, P, Q and T that store the 0th, 20th, 5th, 25th, 40th, 10th, 30th, 15th, 45th and the 35th sequence data respectively are not overwritten with data, as the element areas to be skipped.

Next, in the fifth round, the 58th and the 59th sequence data are written to addresses C and D respectively after addresses A and B that respectively store the 0th and the 20th sequence data have been skipped. Then, after addresses E and F that respectively store the 50th and the 5th sequence data have been skipped, address G is skipped because the data stored at address G is the 51st sequence data that is included in the 10 most recent pieces of data. Similarly, addresses H to T are skipped because they either store one piece of long-term data out of every five pieces of long-term data or store data that is one of the 10 most recent pieces of data.

Furthermore, in the sixth round, the 60th sequence data is written to address A which stores the 0th sequence data being the oldest long-term data. Then, addresses B to F are skipped because they either store one piece of long-term data out of every five pieces of long-term data or store data that is one of the 10 most recent pieces of data, and address G is overwritten with the 61st sequence data. Addresses H and I are skipped because they store one piece of long-term data out of every five pieces of long-term data, and address J is overwritten with the 62nd sequence data. Address K is skipped because address K stores one piece of long-term data out of every five pieces of long-term data, and addresses L and M are overwritten with the 63rd and the 64th sequence data respectively. Addresses N to T are skipped because they either store one piece of long-term data out of every five pieces of long-term data or store data that is one of the 10 most recent pieces of data. Then, in the seventh round, address F which stores 5th sequence data being the oldest long-term data is overwritten with the 65th sequence data, and addresses R and S are overwritten with the 66th and the 67th sequence data respectively.

Note that, as a technique related to recording of data, a technique is known in which search speed of a cache memory is increased by dividing the cache memory for each of N cells and writing to the cache memory from the position corresponding to a remainder obtained by dividing an address on a disk by a predetermined value N.

In addition, a technique is known by which, in accessing a non-volatile memory, an increase in access speed is sought after by, when there is no more unwritten area in a first erasing unit, replacing a second erasing unit with a new first erasing unit by writing effective data in the second erasing unit into a third erasing unit. Furthermore, a technique is also known that enables a high speed data search using a rewrite buffer area provided in each of the divided memory areas to update data recorded in each divided memory area.

Related techniques are disclosed in Japanese Laid-Open Patent Publication Nos. 2003-330796, 2011-128826, and 2008-040594.

### SUMMARY

According to an aspect of the invention, an apparatus includes a buffer area whose size is limited, where the buffer area includes element areas each configured to store a single piece of log information, and the buffer area is configured to be divided into a first log area that stores recent log information and a second log area that stores old log information. When recording a new piece of log information to the buffer area, the apparatus determines whether the new piece of log information is to be recorded in the first log area or in the second log area. The apparatus writes the new piece of log information to the first log area when the new piece of log information is determined to be recorded in the first log area, and writes the new piece of log information to the second log area when the new piece of log information is determined to be recorded in the second log area. When there are no element areas available for the new piece of log information left in the first log area or the second log area, the apparatus changes allocation information configured to allocate each element area in the buffer area to one of the first and second log areas.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is a diagram illustrating an example of a log recording method by an information processing device, according to an embodiment;

FIG. 1B is a diagram illustrating an example of a log recording method by an information processing device, according to an embodiment;

FIG. 1C is a diagram illustrating an example of a log recording method by an information processing device, according to an embodiment;

FIG. 1D is a diagram illustrating an example of a log recording method by an information processing device, according to an embodiment;

FIG. 1E is a diagram illustrating an example of a log recording method by an information processing device, according to an embodiment;

FIG. 1F is a diagram illustrating an example of a log recording method by an information processing device, according to an embodiment;

FIG. 1G is a diagram illustrating an example of a log recording method by an information processing device, according to an embodiment;

FIG. 2 is a diagram illustrating an example of a function configuration of an information processing device, according to an embodiment;

FIG. 3 is a diagram illustrating an example of an operational flowchart for processing by a log recording unit, according to an embodiment;

FIG. 4 is a diagram illustrating an example of an operational flowchart for buffer division processing, according to an embodiment;

FIG. 5 is a diagram illustrating an example of a pseudo-code for buffer division processing, according to an embodiment;

FIG. 6 is a diagram illustrating an example of an operational flowchart for long-term data storage processing, according to an embodiment;

FIG. 7 is a diagram illustrating an example of a pseudo-code for long-term data storage processing, according to an embodiment;

FIG. 8 is a diagram illustrating an example of an operational flowchart for continuous data storage processing, according to an embodiment;

FIG. 9 is a diagram illustrating an example of a pseudo-code for continuous data storage processing, according to an embodiment;

FIG. 10 is a diagram illustrating an example of a hardware configuration of a computer, according to an embodiment;

FIG. 11 is a diagram illustrating an example of a method for recording log data;

FIG. 12 is a diagram illustrating an example of a log data record; and

FIG. 13 is a diagram illustrating an example of a pseudo-code for processing of a log recording method illustrated in FIG. 12.

### DESCRIPTION OF EMBODIMENTS

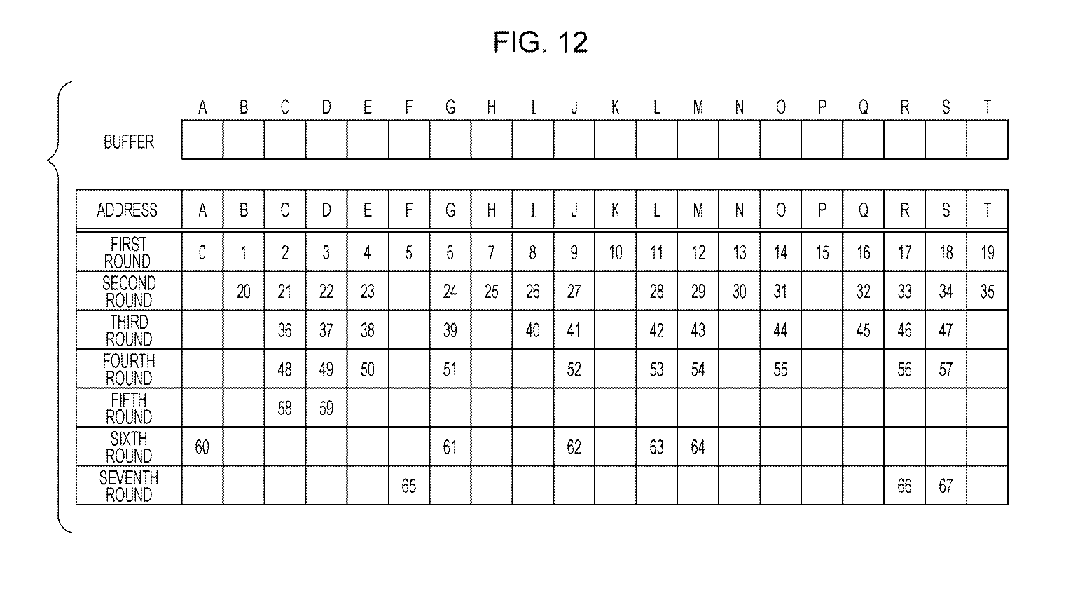

In the log recording method illustrated in FIG. 12, when data is overwritten to the buffer, it is desired to search for (1) an element area that stores data to be overwritten, whose sequence number is not a multiple of p and which is the m-th old data or older, or (2) an element area that stores data to be overwritten, which is the oldest data whose sequence number is a multiple of p. In the example illustrated in FIG. 12, the element areas with addresses B to E, which are to be overwritten with the 20th to the 23rd sequence data respectively in the second round, are examples of the element area of (1), and the element area with address A, which is to be overwritten with the 60th sequence data in the sixth round, is an example of the element area of (2). Such processing to search for an element area that is permitted to be overwritten is time consuming, posing a problem inhibiting log data from being recorded at high speed.

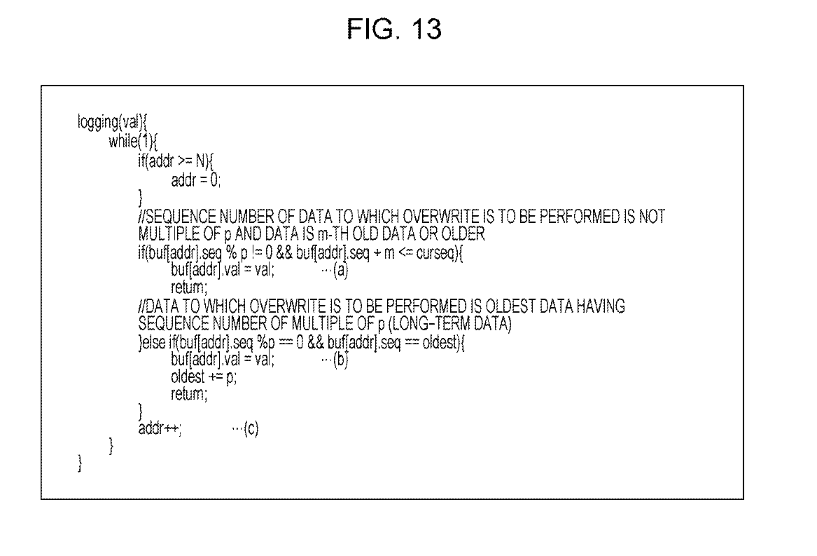

FIG. 13 is a diagram illustrating an example of a pseudo-code for the processing of the log recording method illustrated in FIG. 12. In FIG. 13, “val” indicates data, “buf[ ].val” indicates the storage location of the data, “buf[ ].seq” indicates the corresponding sequence number of the data, and “addr” indicates an index of a buffer. Assignment statement (a) stores data in element area (1), and assignment statement (b) stores data in element area of (2). An element area to store data is searched as “while (1)” and assignment statement (c) increment “addr” by 1, which is time consuming. Furthermore, recording of log data is typically executed by interruption processing, desiring that it is executed at high speed. Writing of log data has to be executed at high speed accordingly. Note that, in the assignment statement (c), “x++” refers to “x=x+1”.

It is desirable to record log data at high speed.

Embodiments of an information processing device, a log recording method, and a log recording program of the technique disclosed herein are described below in detail with reference to the drawings. In the embodiments, “log data” is simply referred to as “data”. In addition, a single piece of log data is stored for a long period of time out of every p pieces of log data, while m pieces of the most recent continuous data are retained. Furthermore, the embodiments do not limit the technique disclosed herein.

### EMBODIMENTS

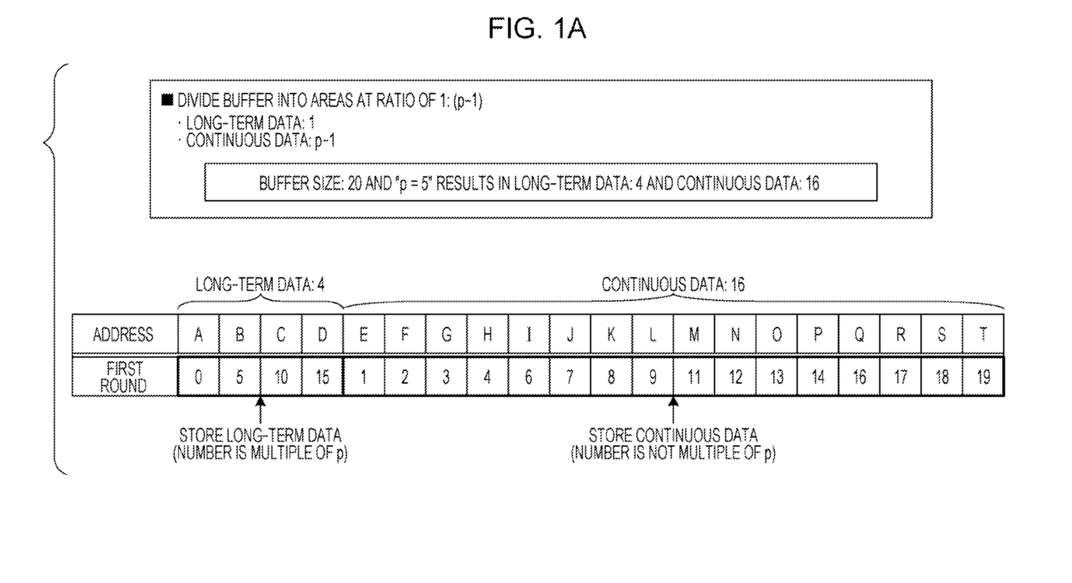

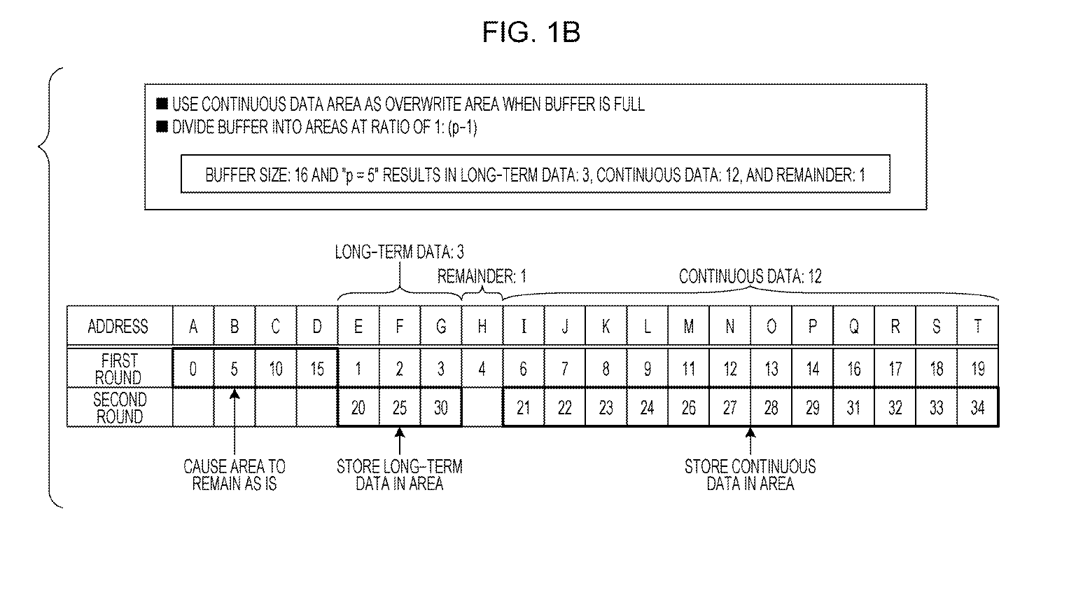

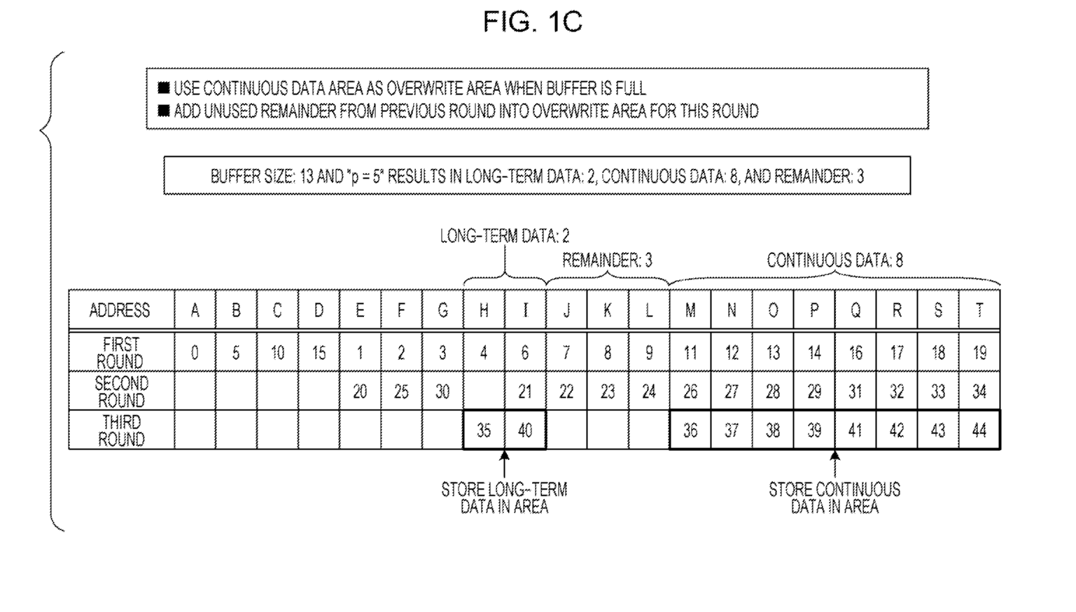

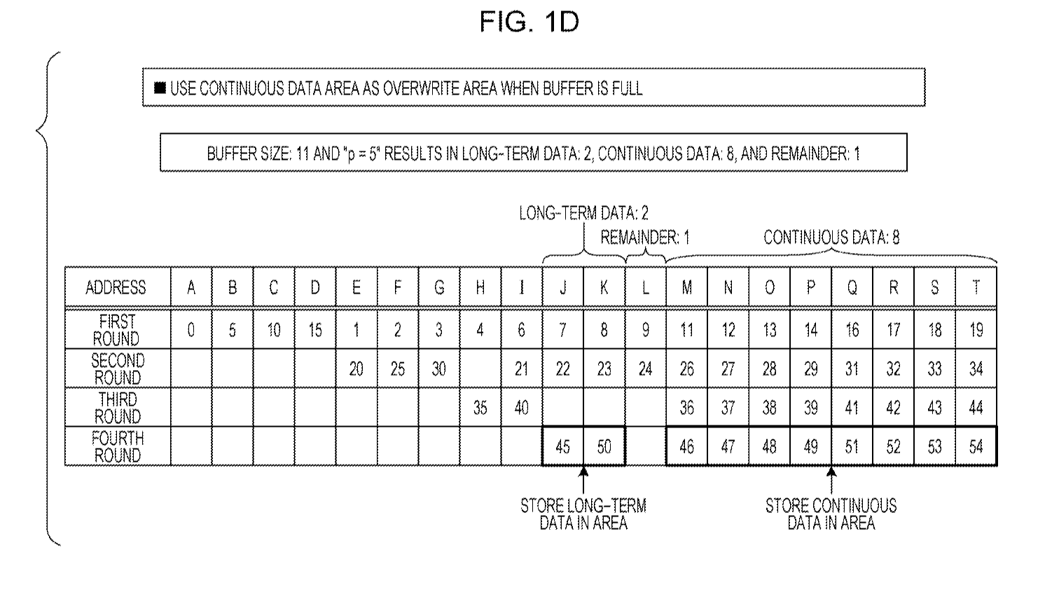

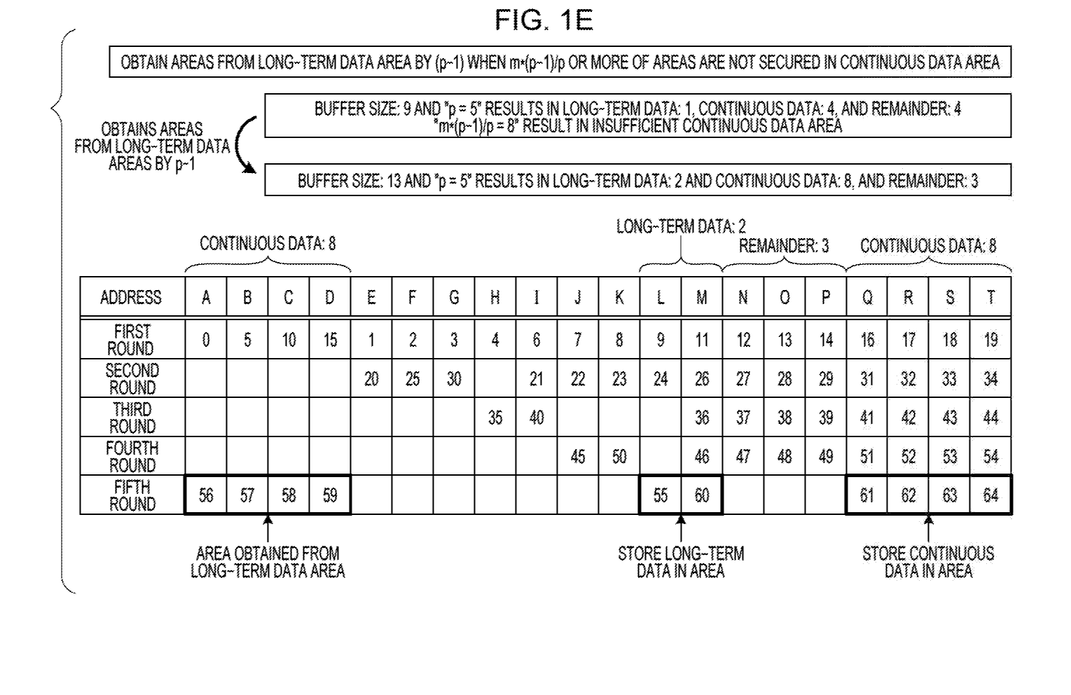

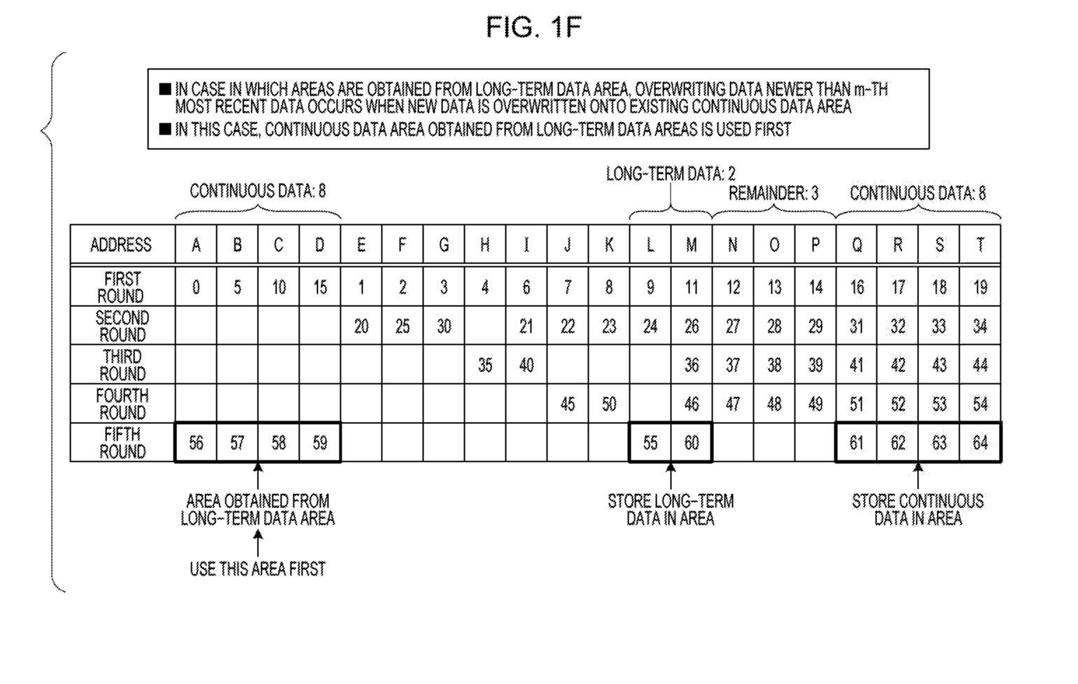

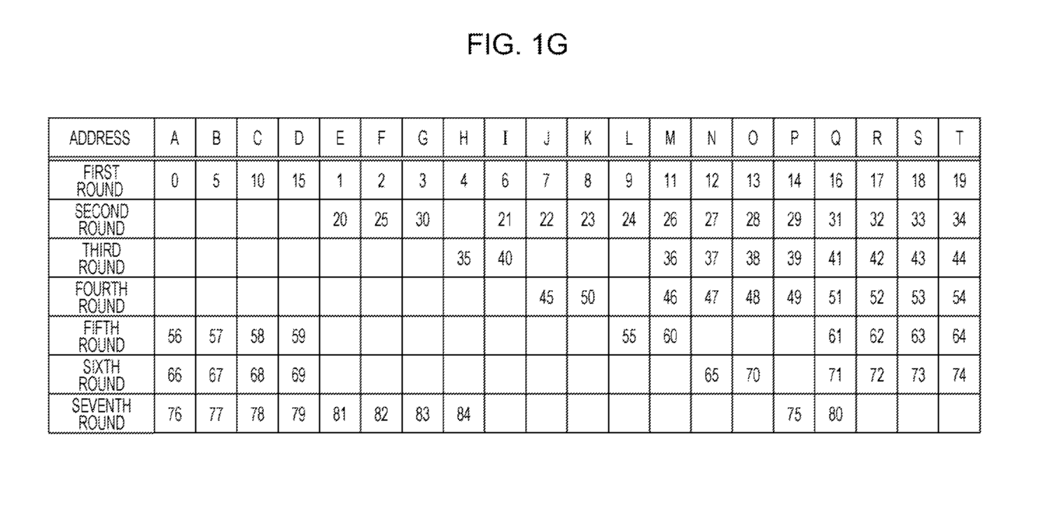

First, a log recording method according to an embodiment is described. FIGS. 1A to 1G are diagrams each illustrating the log recording method by an information processing device according to the embodiment. As illustrated in FIG. 1A, the information processing device according to the embodiment divides a buffer (or a buffer area) into the ratio of 1:(p−1). Long-term data retained for a long period of time are stored in a long-term data area whose proportion in the buffer is 1, and the most recent continuous data retained continuously are stored in a continuous data area whose proportion in the buffer is (p−1). A unit of area in the buffer, in which log data is recorded, is called an element area, and a size of an area in the buffer indicates the number of element areas included in the area. In FIG. 1A, the buffer size is 20 and p=5, resulting in the long-term data area size of 4 and the continuous data area size of 16. Respective addresses A to T are assigned to respective element areas that hold data in the buffer area. Addresses A to D are assigned to element areas that store long-term data, and addresses E to T are assigned to element areas that store continuous data.

As illustrated in FIG. 1A, in the first round, the information processing device stores the 0th sequence data at address A, stores the 1st to 4th sequence data at addresses E to H respectively, stores the 5th sequence data at address B, and stores the 6th to 9th sequence data at addresses I to L respectively. The information processing device further stores the 10th sequence data at address C, stores the 11th to 14th sequence data at addresses M to P respectively, stores the 15th sequence data at address D, and stores the 16th to 19th sequence data at addresses Q to T respectively.

As illustrated in FIG. 1B, when the buffer is full, the information processing device uses the continuous data area as an overwrite area and extends the long-term data area which has become full. Here, assuming that the continuous data area is defined as a new buffer, since the size thereof is 16 and p=5, a size of the long-term data area added by the buffer division becomes 3 and a size of the new continuous data area becomes 12. The initial long-term data area remains as it is, and a size of the unused remainder becomes 1.

In FIG. 1B, element areas with addresses E to G adjacent to the initial long-term data area are added as a long-term data area, an element area with address H is an unused remainder, and element areas with addresses I to T are the new continuous data area. Then, in the second round, the information processing device overwrites address E with the 20th sequence data, overwrites addresses I to L with the 21st to 24th sequence data respectively, overwrites address F with the 25th sequence data, and overwrites addresses M to P with the 26th to 29th sequence data respectively. Moreover, the information processing device overwrites address G with the 30th sequence data, and overwrites addresses Q to T with the 31st to 34th sequence data respectively.

As illustrated in FIG. 1C, when the buffer is full, the information processing device uses the continuous data area as an overwrite area. In addition, the information processing device adds the unused remainder from the previous round into the overwrite area for this round. Accordingly, assuming that the overwrite area is defined as a new buffered, since the buffer size is 13 and p=5, a size of the long-term data area to be added becomes 2, and a size of the new continuous data area becomes 8. The previous long-term data area remains as it is, and a size of the unused remainder becomes 3.

In FIG. 1C, element areas with addresses H to I adjacent to the previous long-term data area are added as a long-term data area, element areas with addresses J to L become unused remainders, and element areas with addresses M to T become the new continuous data area. Then, in the third round, the information processing device overwrites address H with the 35th sequence data, overwrites addresses M to P with the 36th to 39th sequence data respectively, overwrites address I with the 40th sequence data, and overwrites addresses Q to T with the 41st to 44th sequence data, respectively.

As illustrated in FIG. 1D, when the buffer is full, the information processing device uses the continuous data area as an overwrite area. In addition, the information processing device adds the unused remainder from the previous round into the overwrite area for this round. Accordingly, assuming that the overwrite area is defined as a new buffer, since a size of the buffer is 11 and p=5, a size of the long-term data area becomes 2, and a size of the new continuous data area becomes 8. In addition, the previous long-term data area remains as it is, and a size of the unused remainder becomes 1.

In FIG. 1D, element areas with addresses J to K adjacent to the previous long-term data area are added as a long-term data area, an element area with address L is unused remainder, and element areas with the addresses M to T are the new continuous data area. Then, in the fourth round, the information processing device overwrites address J with the 45th sequence data, overwrites addresses M to P with the 46th to 49th sequence data respectively, overwrites address K with 50th sequence data, and overwrites addresses Q to T with the 51st to 54th sequence data respectively.

As illustrated in FIG. 1E, when the buffer is full, the information processing device uses the continuous data area as an overwrite area. In addition, the information processing device adds the unused remainder from the previous round into the overwrite area for this round. Accordingly, assuming that the overwrite area is defined as a new buffer, since a size of the buffer is 9 and p=5, a size of the additional long-term data area becomes 1, and a size of the new continuous data area becomes 4.

Here, in order to hold the most recent m pieces of continuous data, the continuous data area whose size is m*(p−1)/p or greater has to be secured. However, element areas of the continuous data area are insufficient since m*(p−1)/p=8. In this case, the information processing device adds (p−1) element areas, which are sequentially selected from the side of the long-term data area on which older data is being stored, to the buffer. Now, since the buffer size becomes 13 and p=5, a size of the long-term data area added becomes 2, a size of the continuous data area becomes 8, and a size of the unused remainder becomes 3.

In FIG. 1E, element areas with addresses L to M adjacent to the previous long-term data area are added as the additional long-term data area, element areas with addresses N to P are the unused remainder, and element areas with addresses A to D which have been added from the long-term data area to the buffer and element areas with addresses Q to T are the new continuous data area.

Then, in the fifth round, the information processing device overwrites address L with the 55th sequence data. The information processing device then attempts to overwrite address Q with the 56th sequence data. However, since the 51st sequence data has been stored in an element area with address Q, overwriting at address Q would result in overwriting data newer than the m-th most recent data. In this manner, in a case in which part of a long-term data area is added to the buffer, there is a possibility that overwriting of existing continuous data area with new data may result in overwriting data newer than the m-th most recent data. In such a case, as a continuous data area, the information processing device uses an element area in the buffer in the order in which the element area is added from the long-term data area to the buffer.

Namely, as illustrated in FIG. 1F, the information processing device overwrites addresses A to D, which have been added from the long-term data area to the buffer, with the 56th to 59th sequence data, respectively. In addition, the information processing device overwrites the 60th sequence data at address M, and overwrites addresses Q to T with the 61st to 64th sequence data, respectively.

Then, as illustrated in FIG. 1G, in the sixth round, the information processing device overwrites address N with the 65th sequence data, overwrites addresses A to D with the 66th to 69th sequence data respectively, overwrites address O with the 70th sequence data, and overwrites addresses Q to T with the 71st to 74th sequence data respectively. In addition, in the seventh round, the information processing device overwrites address P with the 75th sequence data, overwrites addresses A to D with the 76th to 79th sequence data respectively, overwrites address Q with the 80th sequence data, and overwrites addresses E to H with the 81st to 84th sequence data respectively.

In this manner, the information processing device divides the buffer into the long-term data area and the continuous data area at the ratio of 1:(p−1), stores data to be held for a long time in the long-term data area and stores the most recent continuous data in the continuous data area, thereby recording data at high speed. This is because since data is stored in locations that are determined according to a fixed rule, it is unnecessary for the information processing device to search for storage locations.

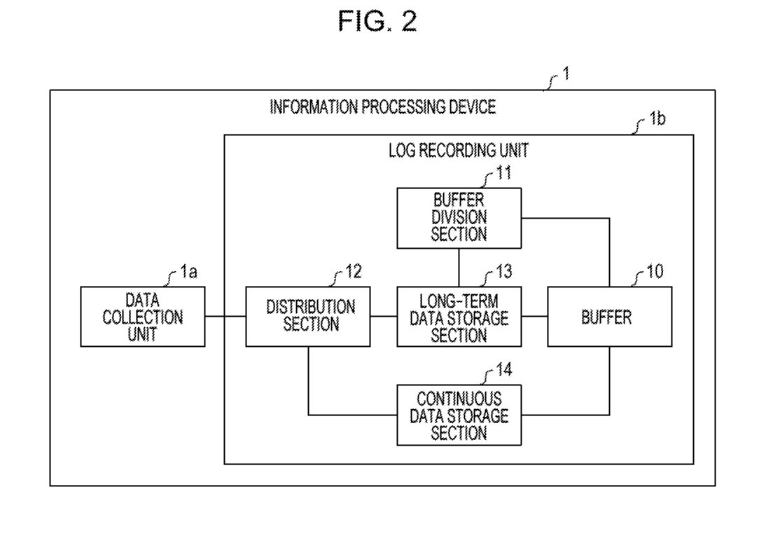

Next, a configuration of the information processing device according to the embodiment is described below. FIG. 2 is a diagram illustrating a function configuration of the information processing device according to the embodiment. As illustrated in FIG. 2, an information processing device 1 includes a data collection unit 1a and a log recording unit 1b.

The data collection unit 1a collects data for the information processing device 1. The log recording unit 1b records the data that has been collected by the data collection unit 1a. The log recording unit 1b includes a buffer 10, a buffer division section 11, a distribution section 12, a long-term data storage section 13, and a continuous data storage section 14.

The buffer 10 is an area in which data is recorded. The size of the buffer 10 is limited, and when the buffer 10 is full, an overwrite is performed to old data. The buffer 10 includes a long-term data area and a continuous data area. The term “buffer” is also used for an overwrite area that is a part of the buffer 10 at the time of buffer division. Therefore, the original buffer is referred to as “buffer 10”, and the overwrite area at the time of buffer division is referred to as “buffer”.

The buffer division section 11 divides the buffer into the long-term data area and the continuous data area at a ratio of 1:(p−1). The buffer division section 11 divides the buffer 10 into the long-term data area and the continuous data area dynamically in the processing in which data is overwritten to the buffer 10. Namely, the buffer division section 11 modifies the allocation information of the long-term data area and the continuous data area when the long-term data area or the continuous data area is insufficient.

When the long-term data area is insufficient, the buffer division section 11 obtains a long-term data area from the continuous data area by the method illustrated in FIGS. 1B to 1G. When the continuous data area is insufficient, the buffer division section 11 obtains a continuous data area from the long-term data area by the method illustrated in FIGS. 1E to 1G.

The distribution section 12 receives the data that has been collected by the data collection unit 1a and determines whether or not the data is to be stored as long-term data, based on the sequence number of the data. Then, the distribution section 12 delivers the data to the long-term data storage section 13 when the data is to be stored as long-term data, and delivers the data to the continuous data storage section 14 when the data is not to be stored as long-term data.

The long-term data storage section 13 stores the data that has been received from the distribution section 12, in the long-term data area. The long-term data storage section 13 requests the buffer division section 11 to perform buffer division when the long-term data area is full.

The continuous data storage section 14 stores the data that has been received from the distribution section 12, in the continuous data area. As illustrated in FIG. 1F, when data stored in an element area to which new data is to be written is newer than the m-th newest data, the continuous data storage section 14 stores data firstly in a continuous data area that has been obtained by the buffer division section 11 from the long-term data area at the time of buffer division.

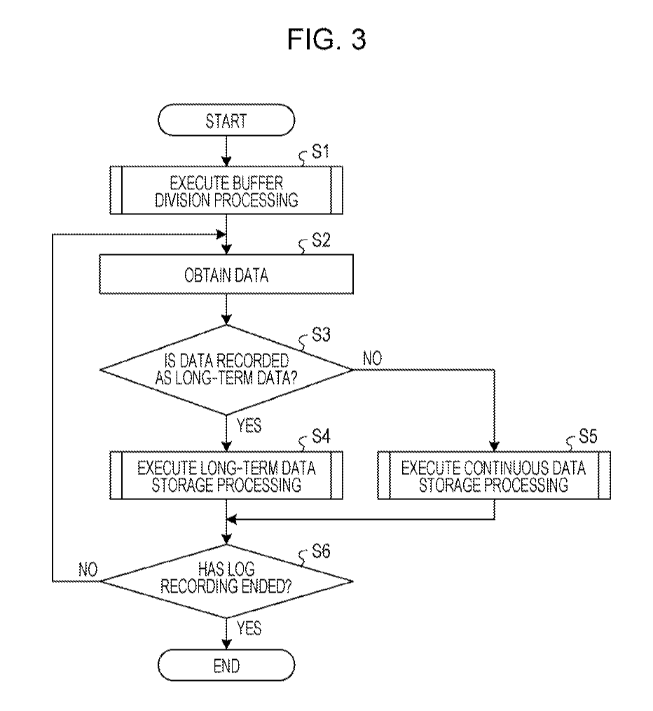

Next, a flow of processing executed by the log recording unit 1b is described. FIG. 3 is an operational flowchart illustrating the flow of the processing executed by the log recording unit 1b. As illustrated in FIG. 3, the log recording unit 1b executes buffer division processing in which buffer division is performed, as initialization processing (Step S1).

The log recording unit 1b obtains data from the data collection unit is (Step S2) and determines whether the obtained data is to be recorded as long-term data or not, based on the sequence number of the data (Step S3).

As a result, when the data is to be recorded as long-term data, the log recording unit 1b executes long-term data storage processing in which the data is stored in the long-term data area (Step S4). On the other hand, when the data is not to be recorded as long-term data, the log recording unit 1b executes continuous data storage processing in which the data is stored in the continuous data area (Step S5).

Then, the log recording unit 1b determines whether or not the log recording has ended (Step S6), and when the log recording has not ended, the processing returns to Step S2, and when the log recording has ended, the processing ends.

In this manner, the log recording unit 1b divides the buffer 10 into the long-term data area and the continuous data area, and stores data in the buffer 10 by distributing the data to the long-term data area and the continuous data area, thereby eliminating the need for searching for storage locations, and enabling recording of data at high speed.

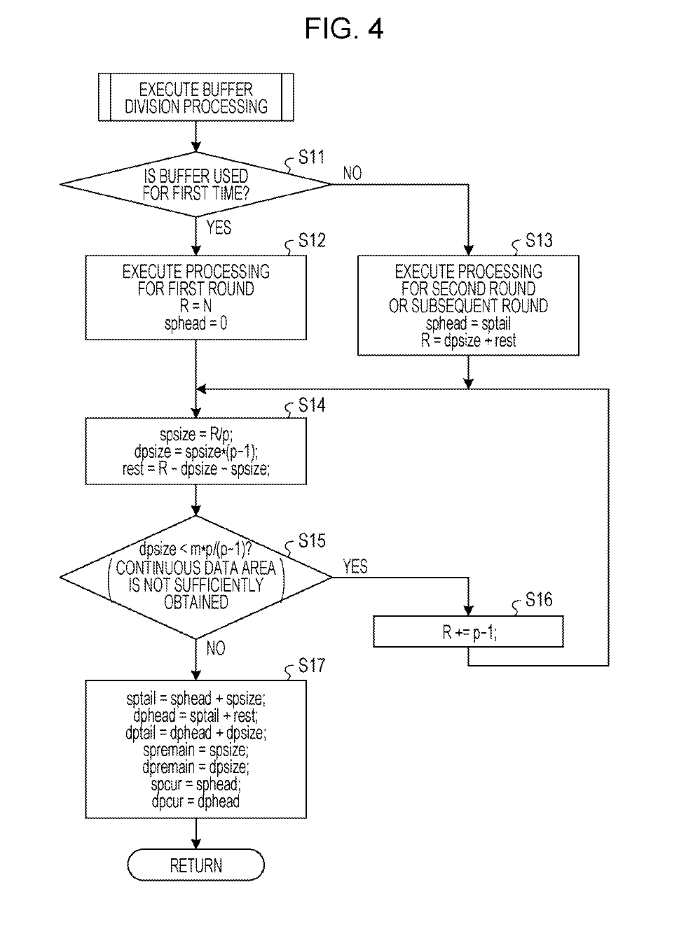

Next, an operational flowchart for the buffer division processing is described. FIG. 4 is an operational flowchart illustrating the flow of the buffer division processing. As illustrated in FIG. 4, the buffer division section 11 determines whether or not the buffer 10 is used for the first time (Step S11).

As a result, when the buffer 10 is used for the first time, the buffer division section 11 executes processing for a first round (Step S12). Specifically, the buffer division section 11 initially sets “R” at “N”, and initially sets “sphead” at 0. Here, “R” is the size of the buffer used for the buffer division at this round, and “N” is a size of the buffer 10, namely the initial size of the buffer used for the buffer division. Furthermore, “sphead” is a pointer that indicates the head of the long-term data area.

On the other hand, when it is not the first time to use the buffer 10, the buffer division section 11 executes processing of a second or a subsequent round (Step S13). Specifically, the buffer division section 11 sets “sphead” at “sptail” and sets “R” at “dpsize+rest”. Here, “sptail” is a pointer that indicates an element area which is next to the last of the long-term data area. Namely, the element area next to the last of the long-term data area in a previous buffer division is the head of the long-term data area used for the current buffer division. “dpsize” indicates the size of the continuous data area, and “rest” indicates the remainder.

In the buffer division section 11, “spsize” is set at “R/p”, “dpsize” is set at “spsize*(p−1)”, and “rest” is set at “R-dpsize-spsize” (Step S14). Here, “spsize” is the size of the long-term data area.

Furthermore, the buffer division section 11 determines whether or not “dpsize” is smaller than “m*p/(p−1)”, namely, whether or not the continuous data area would be insufficient (Step S15). As a result, when “dpsize” is smaller than “m*p/(p−1)”, “p−1” is added to “R” in the buffer division section 11 (Step S16), and the processing returns to Step S14. Note that, in Step S16, “R+=p−1” indicates “R=R+(p−1)”.

On the other hand, when “dpsize” is not smaller than “m*p/(p−1)”, the buffer division section 11 sets allocation information of the long-term data area and the continuous data area, the number of empty areas, and the current storage location, based on the buffer division (Step S17). Specifically, the buffer division section 11 sets “sptail” at “sphead+spsize”, sets “dphead” at “sptail+rest”, and sets “dptail” at “dphead+dpsize”. Furthermore, the buffer division section 11 sets “spremain” at “spsize”, sets “dpremain” at “dpsize”, sets “spcur” at “sphead”, and sets “dpcur” at “dphead”.

Here, “dphead” is a pointer that indicates the head of the continuous data area, “dptail” is a pointer that indicates an element area next to the last of the continuous data area, “spremain” is the number of empty element areas in the long-term data area, and “dpremain” is the number of empty element areas in the continuous data area. “spcur” is a write pointer that indicates a write position of long-term data, and “dpcur” is a write pointer that indicates a write position of continuous data.

In this manner, the buffer division section 11 divides the buffer at a ratio of 1:(p−1), enabling the long-term data area and the continuous data area to be formed.

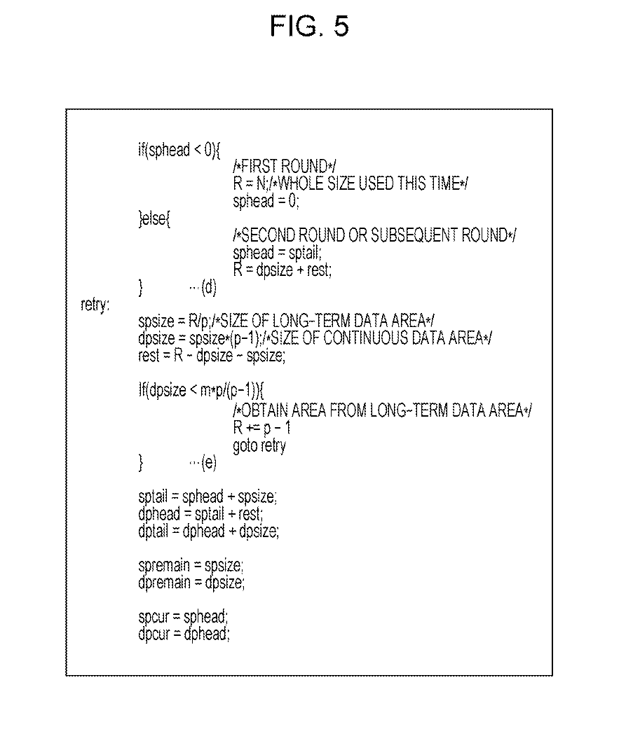

FIG. 5 is a diagram illustrating a pseudo-code for the buffer division processing. As illustrated in FIG. 5, the first if statement (d) determines whether or not the buffer 10 is being used for the first time, and processing for the first round or processing for the second or subsequent round is executed. The second if statement (e) determines whether or not the continuous data area is sufficient, and when the continuous data area is insufficient, processing is executed in which a continuous data area is obtained from the long-term data area.

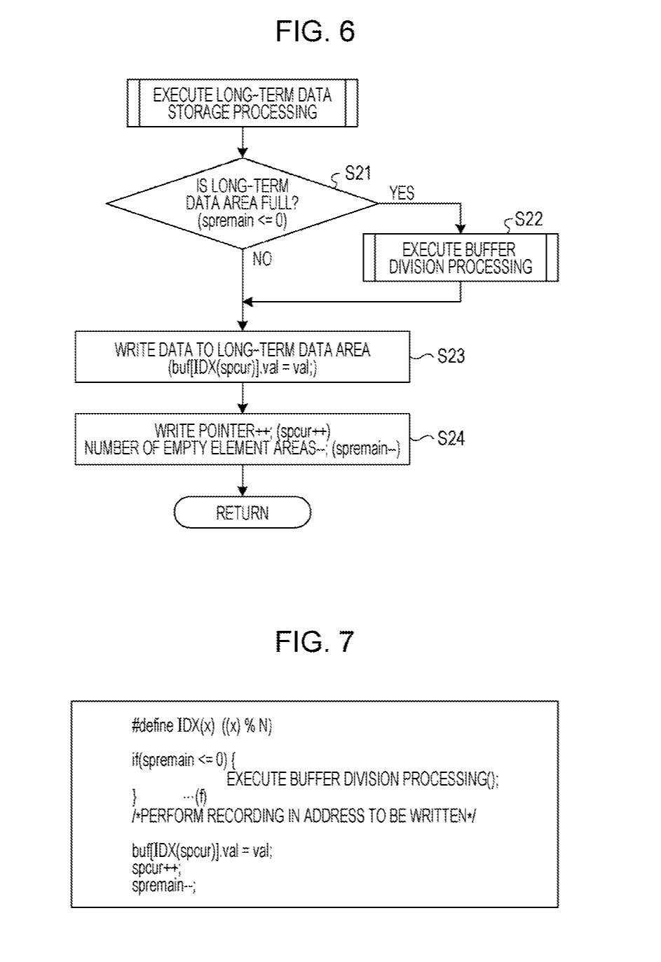

Next, an operational flowchart of the long-term data storage processing is described. FIG. 6 is an operational flowchart illustrating the flow of the long-term data storage processing. As illustrated in FIG. 6, the long-term data storage section 13 determines whether the long-term data area is full (Step S21). Namely, the long-term data storage section 13 determines whether “spremain” is 0 or less.

When the long-term data area is insufficient, the long-term data storage section 13 causes the buffer division section 11 to execute the buffer division processing (Step S22). Then, the long-term data storage section 13 writes data to the long-term data area (Step S23). Namely, “val” is set to “buf[IDX(spcur)].val”. Here, “buf[ ].val” is a data storage section of the buffer 10, and “IDX(spcur)” is the remainder obtained by dividing “spcur” by N. “spcur” monotonically increases, and is converted into an index of the buffer 10 by “IDX”. “val” indicates data to be stored in the buffer.

Then, the long-term data storage section 13 increments a write pointer that indicates the write position of the long-term data by 1, and decrement the number of empty element areas in the long-term data area by 1 (Step S24). Namely, the long-term data storage section 13 increases “spcur” by 1 and decreases “spremain” by 1. Note that in Step S24, “x--” indicates “x=x−1”.

In this manner, when the long-term data area is full, the long-term data storage section 13 is able to newly secure a storage area for long-term data by causing the buffer division section 11 to execute the buffer division processing.

FIG. 7 is a diagram illustrating a pseudo-code for the long-term data storage processing. As illustrated in FIG. 7, whether the long-term data area is full or not is determined by the first if statement (f), and when the long-term data area is full, the buffer division processing is executed.

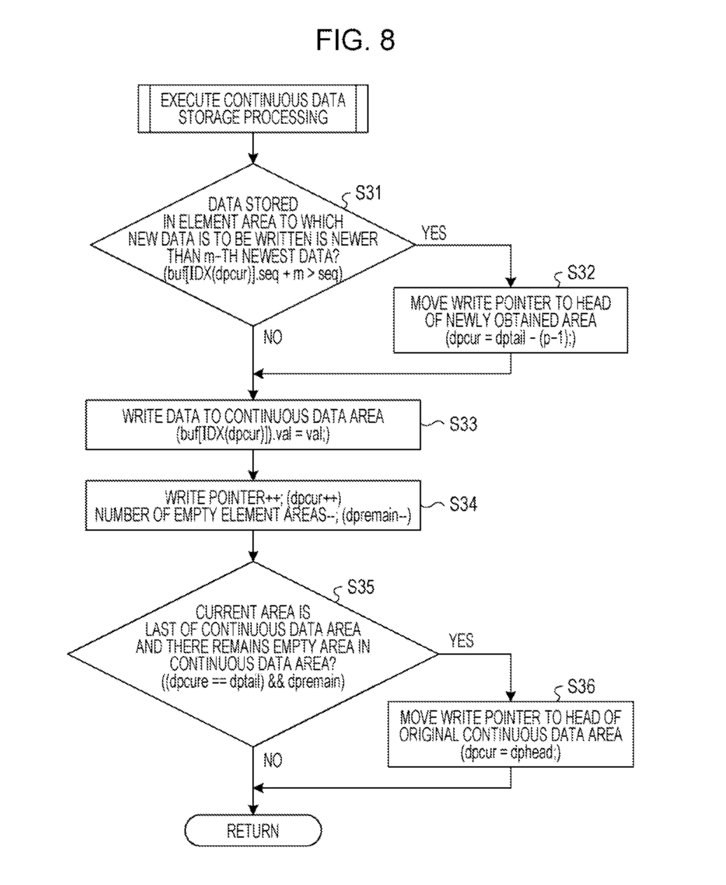

Next, a flow of the continuous data storage processing is described. FIG. 8 is a flowchart illustrating the flow of the continuous data storage processing. As illustrated in FIG. 8, the continuous data storage section 14 determines whether or not data stored in an element area to which new data is to be written is newer than the m-th newest data (Step S31). Namely, the continuous data storage section 14 determines whether or not “buf[IDX(dpcur)].seq+m” is greater than “seq”. Here, “buf[ ].seq” is a sequence number storage section of the buffer 10, and “seq” is the sequence number of the data to be stored.

When data stored in an element area to which data is to be written is newer than the m-th newest data, the continuous data storage section 14 moves the write pointer to the head of an area that has been newly obtained by the buffer division (Step S32). Namely, the continuous data storage section 14 sets “dpcur” at “dptail−(p−1)”.

Then, the continuous data storage section 14 writes data to the continuous data area (Step S33). Namely, “val” is set to “buf[IDX(dpcur)].val”. In addition, the continuous data storage section 14 increments the write pointer that indicates the write position of continuous data by 1, and decrements the number of empty element areas in the continuous data area by 1 (Step S34).

Then, the continuous data storage section 14 determines whether the current area is the last of the continuous data area, and there remains an empty area in the continuous data area (Step S35). Namely, the continuous data storage section 14 determines whether “dpcur” is equal to “dptail”, and “dpremain” is not 0. In Step S35, “dpcur==dptail” indicates that 1 is obtained when “dpcur” is equal to “dptail”, and 0 is obtained when “dpcur” is not equal to “dptail”.

In addition, when the current area is at the last of the continuous data area and there remains an empty area in the continuous data area, the continuous data storage section 14 moves to the head of the original continuous data area (Step S36). Namely, the continuous data storage section 14 sets “dpcur” at “dphead”.

In this manner, when data stored in an element area to which data is to be written is newer than the m-th newest data, the continuous data storage section 14 is able to avoid overwrite to the data newer than the m-th newest data by moving the write pointer to the head of the area that has been newly obtained by the buffer division.

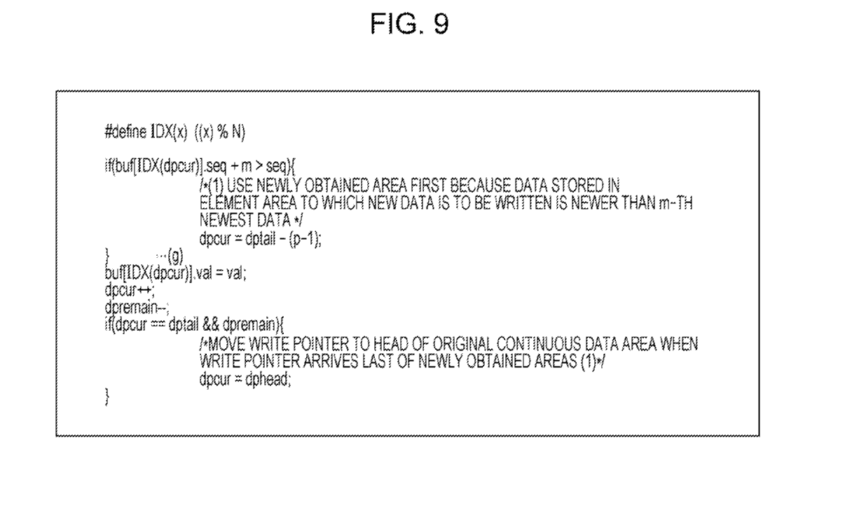

FIG. 9 is a diagram illustrating a pseudo-code for the continuous data storage processing. As illustrated in FIG. 9, the first if statement (g) determines whether data stored in an element area to which data is to be written is newer than the m-th newest data, and when the data is newer than the m-th newest data, the write pointer is moved to the head of an area that has been newly obtained.

As described above, in the embodiment, the distribution section 12 determines whether data is to be stored in the long-term data area, based on the sequence number of the data. As a result, the distribution section 12 distributes the data to the long-term data storage section 13 when the data is to be stored in the long-term data area, and distributes the data to the continuous data storage section 14 when the data is not to be stored in the long-term data area. Then, the long-term data storage section 13 stores the data in the long-term data area, and the continuous data storage section 14 stores the data in the continuous data area. In addition, when the long-term data area is full, the buffer division section 11 performs the buffer division and obtains an additional long-term data area from the continuous data area. Furthermore, when the continuous data area is full, the buffer division section 11 obtains an additional continuous data area from the long-term data area. Accordingly, the log recording unit 1b does not have to search for an element area, to which the log recording unit 1b is able to overwrite data, when the log recording unit 1b writes the data to the buffer 10, thereby enabling data to be recorded at high speed.

Furthermore, in the embodiment, when the long-term data area is full, the buffer division section 11 obtains element areas from the continuous data area and adds them to the long-term data area, the number of such element areas being a quotient obtained by dividing by “p” the size of a new buffer which is the sum of the continuous data area and the remainder. Accordingly, the log recording unit 1b is able to hold the most recent data in the continuous data area while holding the largest possible number of long-term data.

Moreover, in the embodiment, when there is no sufficient room in the continuous data area to store the most recent m pieces of data, the buffer division section 11 obtains p−1 element areas, which are sequentially selected from the side of the long-term data area on which older data is stored, and adds the element areas to the continuous data area. This accordingly ensures that the log recording unit 1b is able to hold the most recent m pieces of data in the buffer 10.

Note that, in the embodiment, explanation have been made regarding the log recording unit 1b, however, a log recording program having functions similar to the log recording unit 1b may be obtained by implementing the configuration of the log recording unit 1b by software. Here, a computer that executes the log recording program is described.

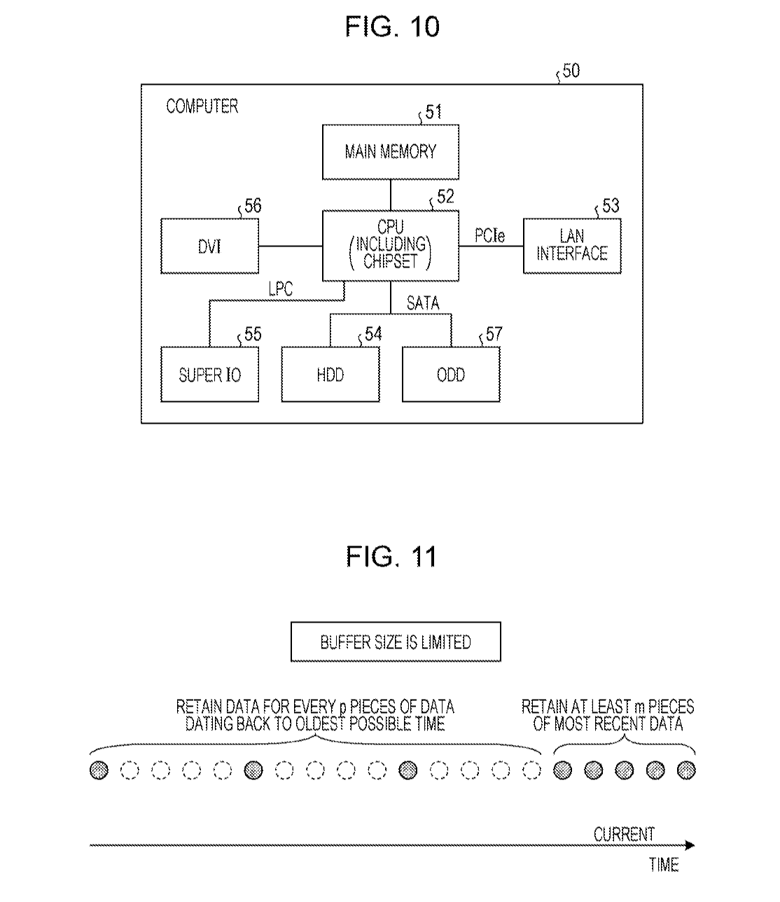

FIG. 10 is a diagram illustrating a hardware configuration of the computer that executes the log recording program according to the embodiment. As illustrated in FIG. 10, a computer 50 includes a main memory 51, a central processing unit (CPU) 52, a local area network (LAN) interface 53, and a hard disk drive (HDD) 54. In addition, the computer 50 further includes a super input/output (IO) 55, a digital visual interface (DVI) 56, and an optical disk drive (ODD) 57.

The main memory 51 is a memory that stores a program, a result obtained when a program is being executed, and the like. The CPU 52 is a central processing device that reads a program from the main memory 51 and executes the program. The CPU 52 includes a chipset including a memory controller.

The LAN interface 53 is an interface used to connect the computer 50 to another computer through a LAN. The HDD 54 is a disk device that stores programs and data, and the super IO 55 is an interface used to connect an input device such as a mouse and a keyboard. The DVI 56 is an interface used to connect a liquid crystal display device, and the ODD 57 is a device that performs reading and writing of a digital versatile disc (DVD).

The LAN interface 53 is connected to the CPU 52 through PCI-express (PCIe), and the HDD 54 and the ODD 57 are connected to the CPU 52 through Serial Advanced Technology Attachment (SATA). The super IO 55 is connected to the CPU 52 through Low Pin Count (LPC).

The log recording program executed by the computer 50 is stored in a DVD, read from the DVD through the ODD 57, and installed to the computer 50. Alternatively, the log recording program is stored in a database or the like of another computer system connected through the LAN interface 53, read from such database and installed to the computer 50. Then, the installed log recording program is stored in the HDD 54, read into the main memory 51, and executed by the CPU 52.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An apparatus comprising:
a memory including a buffer area whose size is limited, the buffer area including element areas each configured to store a single piece of log information, the buffer area being configured to be divided into a first log area that stores recent log information and a second log area that stores old log information; and
a processor coupled to the memory and configured to:
when recording a new piece of log information to the buffer area, determine whether the new piece of log information is to be recorded in the first log area or in the second log area,
write the new piece of log information to the first log area when the new piece of log information is determined to be recorded in the first log area,
write the new piece of log information to the second log area when the new piece of log information is determined to be recorded in the second log area, and
when there are no element areas available for the new piece of log information left in the first log area or the second log area, change allocation information configured to allocate each element area in the buffer area to one of the first and second log areas.

2. The apparatus of claim 1, wherein
the processor is configured to:
define a size of the first log area as a number of element areas included in the first log area, and a size of the second log area as a number of element areas included in the second log area;
write p−1 pieces of log information from among p pieces of log information to the first log area, where p is a positive integer;
write a piece of log information from among the p pieces of log information to the second log area; and
when there are no available element areas left in the second log area, change the allocation information such that element areas in the first log area, whose number is equal to a quotient obtained by dividing the size of the first log area by p included in the first log area, are allocated to the second log area, and change a size of the second log area to a size obtained by multiplying the quotient by p−1.

3. The apparatus of claim 2, wherein
in a case of continuously storing at least most recent m pieces of log information in the first log area where m is a positive integer, when a number obtained by multiplying the quotient by p−1 is less than a number obtained by multiplying m by (p−1)/p, the processor changes the allocation information by allocating a predetermined number of continuous element areas in the second log area to the first log area, the predetermined number of continuous element areas being element areas of the second log area in which older pieces of log information are being stored.

4. A method causing a computer to execute a process, the process comprising:
providing a buffer area whose size is limited, the buffer area including element areas each configured to store a single piece of log information, the buffer area being configured to be divided into a first log area that stores recent log information and a second log area that stores old log information;
when recording a new piece of log information to the buffer area, determining whether the new piece of log information is to be recorded in the first log area or in the second log area;
writing the new piece of log information to the first log area when the new piece of log information is determined to be recorded in the first log area;
writing the new piece of log information to the second log area when the new piece of log information is determined to be recorded in the second log area; and
when there are no element areas available for the new piece of log information left in the first log area or the second log area, changing allocation information configured to allocate each element area in the buffer area to one of the first and second log areas.

5. A non-transitory, computer-readable recording medium having stored therein a program for causing a computer to execute a process, the processing comprising:
providing a buffer area whose size is limited, the buffer area including element areas each configured to store a single piece of log information, the buffer area being configured to be divided into a first log area that stores recent log information and a second log area that stores old log information;
when recording a new piece of log information to the buffer area, determining whether the new piece of log information is to be recorded in the first log area or in the second log area;
writing the new piece of log information to the first log area when the new piece of log information is determined to be recorded in the first log area;
writing the new piece of log information to the second log area when the new piece of log information is determined to be recorded in the second log area; and
when there are no element areas available for the new piece of log information left in the first log area or the second log area, changing allocation information configured to allocate each element area in the buffer area to one of the first and second log areas.
